(19) United States
(12) Patent Application Publication
(10) Pub. No.: US 2013/0212903 A1
(43) Pub. Date: Aug. 22, 2013

(54) DRYING DEVICE AND DRYING METHOD

(71) Applicant: Kazuhiro Onose, Kamikawa-gun (JP)

(72) Inventor: Kazuhiro Onose, Kamikawa-gun (JP)

(21) Appl. No.: 13/811,345

(22) PCT Filed: Jul. 25, 2011
(86) PCT No.: PCT/JP2011/066839

§ 371 Date: Jan. 21, 2013

(30) Foreign Application Priority Data
Jul. 23, 2010 (JP) 2010-179804

(51) Int. Cl. F26B 7/00

(52) U.S. Cl. CPC F26B 7/00
USPC 34/376; 34/102; 34/79

(57) ABSTRACT

A device for allowing efficient drying and a method thereof are established by increasing the opportunity and area to bring a drying object into contact with air and a method for producing dry fermented feed and dry fermented manure at low costs by using the fermentation heat is proposed.

The drying object is floated while shifting and stirring the drying object in the drying vessel, and air is supplied from below, and the drying object is transported by an air current repeatedly from a lower part to an upper part of the drying vessel to increase the opportunity and area to bring the drying object into contact with dry air evenly and significantly improve shortening of time spent for drying. By arranging air injection nozzles to generate an induced air current in the outside of an air current for blowing the drying object along with air to a lower inner wall and a curved inner wall of the circulation exhaust port in the circulation duct, the drying object is prevented from being damaged in the duct and smooth circulation thereof is realized, whereby an evenly dried product of good quality can be obtained. As for a drying object under a fermentation process, the opportunity and area to bring the drying object into contact with air evenly is increased in a stored place and transport by an air current so as to accelerate fermentation and drying, significantly improve shortening of time spent for drying, and produce a uniform quality product whose value is added by fermentation such as fermented feed/fermented manure of animal and plant residue, without using new thermal power.

### TECHNICAL FIELD

The present invention relates to a dryer and a drying method and in particular relates to a technique for drying a drying object while circulating it in a drying vessel.

### BACKGROUND ART

The invention according to Patent Literature 1 by the applicant of this case is a device for producing dry fermented feed and dry fermented manure of animal and plant residue in which fermentation heat generated by adding fermentation bacteria to an animal and plant residue is used to circulate a drying object repeatedly in combination with air in the device.

This invention is characterized by an integral configuration of a fermentation vessel, a screw conveyer, a circulation duct, an exhaust duct and a product storage vessel in order to dry an animal and plant residue while circulating it and to transport a fermented and dried product along with an exhaust emitted from an exhaust duct to a product storage vessel.

### CITATION LIST

### Patent Literature

Patent Literature 1: Japanese Patent No. 4221617

### SUMMARY OF INVENTION

### Technical Problem

In the device disclosed in the above Patent Literature 1, a space to load and discharge a drying object is limited, resulting in other limitations such as machine installation space. This device is also limited structurally to result in restriction of a versatile arrangement of each component element and expansion and reduction of the scale.

According to the above disclosed device, the drying object is left at rest in a deposited/stored place, which takes time to prepare a dried product.

A drying object may be damaged and adhere in the device during circulation.

When an organic substance under a fermentation process is dried, fermentation is further accelerated and drying time is shortened in order to produce dry fermented feed and dry fermented manure of good quality.

### Solution to Problem

In order to solve the above problems, the present invention uses the following means.

That is, a dryer is provided comprising a drying vessel being a container for stirring and drying a drying object in combination with air in the inside thereof; a hopper arranged below an exhaust port provided in a lower part of the drying vessel; transport means connected to the hopper and having a product exhaust port for allowing a dried product to be taken out in a transport process, and a circulation exhaust port; and circulation drying means for guiding a drying object discharged from the circulation exhaust port of the transport means to an upper part of the drying vessel while drying the drying object with an air current generated by blower means; wherein a drying object is dried in at least the drying vessel and the circulation drying means while circulating the drying object.

The device may be provided with solid-gas separation means to separate a drying object into a solid and gas by introducing an air current in the above circulation drying means and loading a drying object into the drying vessel again.

The present invention may also be configured by forming the above drying vessel into a substantially cylindrical container and providing, in the drying vessel, a rotary shaft arranged in a shaft direction of the substantially cylindrical vessel; injection tubes extended to a centrifugal direction from the rotary shaft and having injection holes for injecting pressure air upward; plates installed obliquely so as to cover the injection holes of the injection tubes from above the injection holes; and pressure air blowing means for supplying pressure air to the injection tubes.

A drying object under a drying process is floated while shifting and stirring the drying object in the drying vessel in which the drying object is deposited and stored, and air is supplied from below, whereby facilitating drying and enabling further shortening of time spent for preparing a product.

In a configuration of using a circulation duct as the circulation drying means, an air injection nozzles may be arranged to supply compressed air so as to generate an induced air current for protecting a drying object in the outside of an air current in an inner wall of the circulation duct.

When the drying object is transported by an air current from a lower part to an upper part of the drying vessel repeatedly, a drying object can be circulated smoothly with reduced damages and adherence of a drying object.

The present invention can also provide the following drying method in addition to the above dryer.

That is, the method is characterized in that a drying object is discharged from a lower part of the drying vessel being a container for stirring and drying a drying object in combination with air in the inside thereof; a drying object is guided to an upper part of the drying vessel while blowing the drying object with an air current generated in the circulation drying means; and a drying object is loaded into the drying vessel again, whereby a drying object is scattered and brought into contact with air frequently in the drying vessel and the circulation drying means for improving drying efficiency.

### Advantageous Effects of Invention

As stated above, the drying vessel, the hopper having the transport means such as screw conveyer, the circulation drying means and the solid-gas separation means such as cyclone are composed separately to secure means for loading various kinds of drying objects and make it easier to discharge a dried object being a product obtained after drying or other objects, allowing versatility in designing the dryer and easy expansion and reduction of the scale.

It is also possible to provide the dryer not only for fermenting and drying an animal and plant residue but also for applying to various kinds of drying objects.

By having the means for separating a drying object into a solid and gas with respect to an air current in the circulation drying means, a drying object which is scattered in the air current can be loaded into the drying vessel efficiently. In particular, a drying object can be loaded in a predetermined position of the drying vessel, whereby stabilizing the flow of an air current in the drying vessel and contributing to efficient drying.

The drying object is floated while shifting and stirring the drying object in the drying vessel and air is supplied from below, and the drying object is transported by an air current repeatedly from a lower part to an upper part of the drying vessel to increase the opportunity and area to bring the drying object into contact with dry air evenly and substantially shortening the time spent for drying. By arranging the air injection nozzles to further generate an induced air current in the outside of an air current for blowing the residue along with air to a lower inner wall and a curved inner wall of the circulation exhaust port in the circulation duct serving as the circulation drying means, the drying object is prevented from being damaged and adhering in the device and smooth circulation thereof is realized in the device so that an evenly dried state can be obtained.

In the drying vessel which is a storage space, air is supplied evenly while stirring an organic substance under a fermentation process so as to further accelerate fermentation, enhance generation of fermentation heat, use fermentation heat, and increase the opportunity and area to bring the drying object into contact with air, whereby enabling drying without using new thermal power and making the time spent for drying significantly shorter. As a result, dry fermented feed and dry fermented manure that are uniform and high in the nutritive value can be produced with preservation of energy.

### BRIEF DESCRIPTION OF DRAWINGS

FIG. 1 is a schematic view of a dryer according to one embodiment of the present invention.

FIG. 2 is a detail view in relation to air injection tubes and plates and other components according to the present invention.

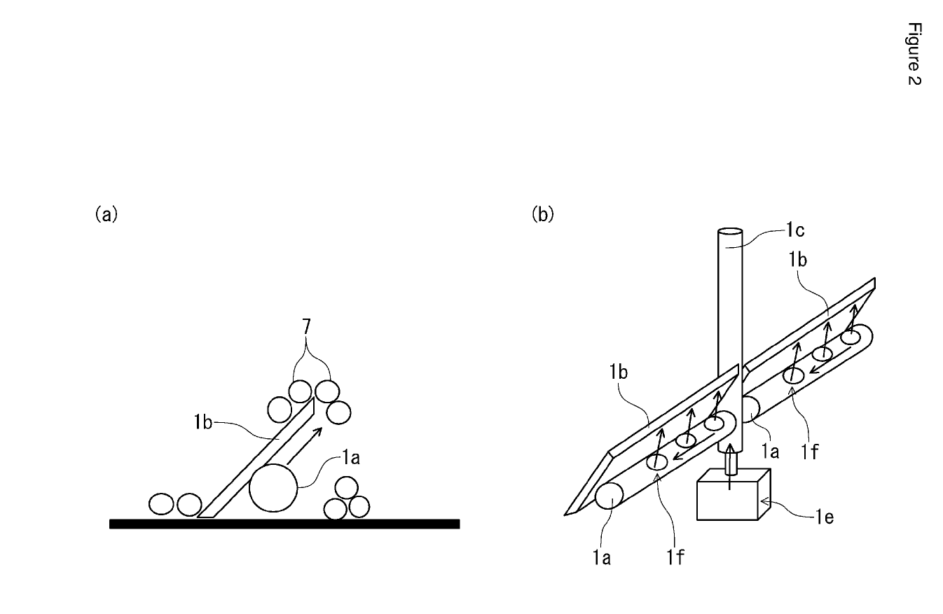

### DESCRIPTION OF EMBODIMENTS

Explained below will be an embodiment of the present invention by referring to the drawings.

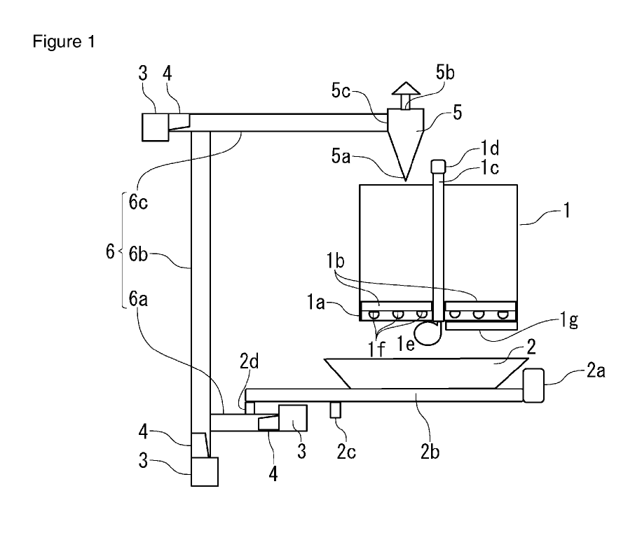

As shown in FIG. 1, a dryer according to the present invention is composed of a cyclone 5 arranged in an upper area by including an induction port 5c, an exhaust port 5a and an outlet 5b, and components arranged in a lower area including a drying vessel 1 being a container having an exhaust port 1g, a hopper 2 which is placed below the exhaust port 1g and has, in a lower part thereof, a circulation exhaust port 2d, an opening/closing product exhaust port 2c and a screw conveyer 2b containing a motor 2a, and a circulation duct 6 continued from the circulation exhaust port 2d and stretched from a blower 3 to the induction port 5c of the cyclone 5.

For the cyclone 5, known means for use in solid-gas separation can be used, for example, a method of using a bag filter and/or a configuration of using other dust collectors.

The present invention may also be configured by dropping a drying object from the circulation duct 6 to the drying vessel 1 depending on the type of a drying object, wherein the cyclone 5 may not be necessarily arranged.

Owing to the hopper 2 arranged below the drying vessel 1, a drying object of a fixed amount can be guided to the circulation duct 6 evenly and a backflow due to a blow by the blower 3 can be prevented. The screw conveyer can be replaced with known transport means and not only a belt conveyer but also a transport method by air pressure such as, for example, vacuum conveyer may be also employed.

As circulation drying means according to the present invention, the present embodiment is provided with the circulation duct 6 which is made of a circulation lower duct 6a, a circulation vertical duct 6b and a circulation upper duct 6c. Each of the ducts is provided with the blower 3 and an air injection nozzle 4, wherein a drying object has an opportunity to come into contact with air frequently with the help of an air current generated by the blowers 3 in the middle of transfer. The circulation duct 6 may be composed of any number of combined ducts and the combination can be appropriately changed according to the installation site and size.

In addition, the circulation drying means according to the present invention is not limited to the circulation duct and may also be realized in a configuration of flying a drying object upward with a wind pressure from a lower part of the drying vessel 1 by using a blower in a similar manner as a snow throwing mechanism of a snow plow, for example.

According to the present invention, it is further possible to form the drying vessel 1 into a cylindrical container, in which a rotary shaft 1c is arranged to facilitate stirring in the vicinity of the vessel of the rotary shaft 1c, air injection tubes la having holes 1f serving as air supply ports are arranged, plates 1b are installed obliquely so as to cover the holes 1f of the injection tubes 1a from above the holes 1f, and the injection tubes 1a are provided with a blower 1e which is in communication with the holes 1f by passing through the inside of the rotary shaft.

Owing to rotational action of the rotary shaft 1c and the plates 1b, a drying object is stirred in the drying vessel 1 and a drying object is flown upward by a blow sent from the air injection tubes 1a. Therefore, a drying object can be brought into contact with air evenly in the drying vessel 1 and thus prevented from remaining in the vessel and being dried unevenly.

In the circulation duct 6, a blow from the blowers 3 is preferably injected by the air injection nozzles 4 so as to generate an induced air current in the outside of an air current in a lower inner wall and a curved inner wall of the circulation duct 6 arranged below the circulation exhaust port 2d. Therefore, a drying object is prevented from being damaged and adhering in the device and smooth circulation is realized in the device so that an even dried state can be obtained.

A drying object is loaded by arranging a space to load a drying object in any of the drying vessel 1, the hopper 2, the cyclone 5 and the circulation duct 6, and air sent from the blower 1e is supplied to a drying object from below by using the holes 1f arranged in the air injection tubes 1a while floating the drying object by the air injection tubes 1a with the obliquely installed plates 1b in the drying vessel 1, followed by transferring a drying object to the exhaust port 1g, discharging the drying object from the exhaust port 1g to the hopper 2, and transferring/discharging the drying object to the circulation exhaust port 2d by the screw conveyer 2b, after which a discharged drying object is blown with compressed air sent from the blowers 3 in the inside of the circulation duct 6 and transferred to an upper part of the drying vessel 1 through separation from air by using the cyclone 5. The drying object is also prevented from colliding and adhering to inner walls in the circulation duct 6 by arrangement of an induced air current in the outside of an air current for blowing a drying object and drying is accelerated by increasing the opportunity and area to bring a drying object into contact with air resulting from smooth and repetitive circulation in the device, after which a dried product is discharged from the opened product exhaust port 2c.

### REFERENCE SIGNS LIST

1 DRYING VESSEL
1a AIR INJECTION TUBE
1b PLATE
1c ROTARY SHAFT
1d MOTOR
1e BLOWER
1f HOLE
1g EXHAUST PORT
2 HOPPER
2a MOTOR
2b SCREW CONVEYER
2c PRODUCT EXHAUST PORT
2d CIRCULATION EXHAUST PORT
3 BLOWER
4 AIR INJECTION NOZZLE
5 CYCLONE
5a EXHAUST PORT
5b OUTLET
5c INDUCTION PORT
6 CIRCULATION DUCT
6a CIRCULATION LOWER DUCT
6b CIRCULATION VERTICAL DUCT
6c CIRCULATION UPPER DUCT

1. A dryer comprising:
a drying vessel being a container for stiffing and drying a drying object in combination with air in the inside thereof;
a hopper arranged below an exhaust port provided in a lower part of the drying vessel;
transport means connected to the hopper and having a product exhaust port for allowing a dried product to be taken out in a transport process, and a circulation exhaust port; and
circulation drying means for guiding a drying object discharged from the circulation exhaust port of the transport means to an upper part of the drying vessel while drying the drying object with an air current generated by blower means; wherein
a drying object is dried in at least the drying vessel and the circulation drying means while circulating the drying object.

2. The dryer according to claim 1, wherein
solid-gas separation means is provided to separate a drying object into a solid and gas by introducing an air current in the circulation drying means and loading a drying object into the drying vessel again.

3. The dryer according to claim 1, wherein
the drying vessel is formed into a substantially cylindrical container and the drying vessel internally contains:
a rotary shaft arranged in a shaft direction of the substantially cylindrical vessel;
injection tubes extended to a centrifugal direction from the rotary shaft and having injection holes for injecting pressure air upward;
plates installed obliquely so as to cover the injection holes of the injection tubes from above the injection holes; and
pressure air blowing means for supplying pressure air to the injection tubes.

4. The dryer according to claim 1, wherein
a circulation duct is used as the circulation drying means and air injection nozzles are arranged to supply compressed air so as to generate an induced air current for protecting a drying object in the outside of an air current in an inner wall of the circulation duct.

5. A drying method characterized in that:
a drying object is discharged from a lower part of a drying vessel being a container for stirring and drying a drying object in combination with air in the inside thereof;
a drying object is guided to an upper part of the drying vessel while blowing the drying object with an air current generated in circulation drying means; and
a drying object is loaded into the drying vessel again, whereby
a drying object is scattered and brought into contact with air frequently in the drying vessel and the circulation drying means for improving drying efficiency.

6. The drying method according to claim 5, wherein
the drying method includes, before loading a drying object into the drying vessel again from the circulation drying means,
a process to separate a drying object into a solid and gas by the air current.

7. The drying method according to claim 5, wherein
in a configuration of using a circulation duct as the circulation drying means, an air current is arranged outside a circulation air current in the circulation duct in order to prevent a drying object from coming into contact with the circulation duct and protect a drying object.

8. A method for fermenting/drying animal and plant residue characterized in that
the drying object according to claim 5 is an animal and plant residue under a fermentation process, and fermentation is accelerated by increasing the opportunity and area to bring a drying object into contact with air by blowing and scattering a drying object in combination with air, using heat of the fermentation for drying.

9. The method for fermenting/drying animal and plant residue according to claim 8, wherein in a storage space for facilitating fermentation of a deposited animal and plant residue, the animal and plant residue is floated while shifting the animal and plant residue and air is supplied to the floated animal and plant residue so as to increase the opportunity and area to bring the animal and plant residue into contact with air and accelerate fermentation and drying, whereby shortening the time spent for preparing a finished product.

10. The method for fermenting/drying animal and plant residue according to claim 8, wherein in circulation of an animal and plant residue under a fermentation process, a wet residue is prevented from adhering and being damaged in the dryer by arrangement of an air current in the outside of a circulation air current.
